(19) United States
(12) Patent Application Publication
(10) Pub. No.: US 2025/0031692 A1
(43) Pub. Date: Jan. 30, 2025

(54) HIGH LOAD SUSPENSION CONCENTRATE COMPOSITIONS

(71) Applicant: ADAMA AGAN LTD., Ashdod (IL)

(72) Inventors: Liron HEVRONI, Meitar (IL); Gilad SILBERT, Kibbutz Dorot (IL)

(73) Assignee: ADAMA AGAN LTD., Ashdod (IL)

(21) Appl. No.: 18/713,991

(22) PCT Filed: Nov. 27, 2022
(86) PCT No.: PCT/IL2022/051259

§ 371 Date: May 28, 2024

Related U.S. Application Data
(60) Provisional application No. 63/283,471, filed on Nov. 28, 2021.

(51) Int. Cl. A01N 25/04; A01N 25/32; A01N 43/54; A01N 43/80; A01P 13/00

(52) U.S. Cl. CPC A01N 25/04; A01N 25/32; A01N 43/54; A01N 43/80; A01P 13/00

(57) ABSTRACT

The present invention relates to high loaded suspension concentrate (SC) composition comprising a pesticide, a block copolymer, composed of a hydrophobic block and a hydrophilic block which contains negatively charged moieties (Poly Agro) and at least one non-ionic surfactant. Also, the present invention describes, a high loaded suspension concentrate (SC) composition, wherein: pyroxasulfone or saflufenacil is about 62 w/w % or is about 53 w/w %, respectively, with respect to the total weight on the composition: Poly Agro is from about 1 to about 10 w/w % with respect to the total weight on the composition; and at least one non-ionic surfactant is from about 1 to about 15 w/w % with respect to the total weight of the composition.

### FIELD OF THE INVENTION

The present invention is from the field of agrochemistry. It is directed to high load suspension concentrate (SC) formulations and stable high load compositions for agricultural applications, to processes for their preparation and to methods and uses as pesticides.

### BACKGROUND

A suspension concentrate (SC) formulation, also known as a flowable, is a liquid formulation that contains stable suspension of a solid pesticide active ingredient in a fluid usually intended for dilution with water before use. Formulations of these pesticides usually contain the active ingredient, solvent (carrier or diluent), and one or more other ingredients. This type of formulations is very important and widely spread in the agrochemistry field. Namely because of the easiness to handle and measure; no agitation required; little visible residue on the plant; does not wear sprayer parts or plug screens or nozzles; seldom leaves visible residue. They have many advantages; however, several serious difficulties make the creation of such formulations, challenging. The SC formulation must show long term stability and stability upon dilution.

The requirements for a high loaded stable SC composition, create a major hurdle in the creation of said high loaded SC formulations. Caking, skinning and sedimentation, are some of the problems, which arise when formulating high load SC compositions.

Also, additional problems may arise when trying to formulate a SC formulation, such as crystal growth and incompatibility with water soluble active ingredients.

Publication WO 2017/098325 talks about polyelectrolyte-layer forming block copolymers and compositions and uses thereof. Namely, said publication relates to the use of a polyelectrolyte-layer forming block copolymer as a dispersant or emulsifier wherein the block copolymers adsorb on the surfaces of the active ingredient particles in a dispersion to result in a stable brushed “particle-polymer” complex. Accordingly, the compositions of WO 2017/098325 publication have a reduces friction between particles and stabilize dispersions in a very efficient way. Also, by combining steric and ionic stabilization they preform well at both high and low concentrations of electrolytes. The block copolymer has an anchoring moiety and at least one stabilizing moiety, wherein the block copolymer is adsorbed on hydrophobic surfaces of the agricultural material compound particles. According to the WO 2017/098325 publication the compositions comprising the polyanionic polymers can be an emulsion, a suspension concentrate, a capsule suspension, or a suspo-emulsion.

### SUMMARY OF THE INVENTION

The present invention provides a high loaded suspension concentrate (SC) composition comprising (i) a pesticide, (ii) a block copolymer, composed of a hydrophobic block and a hydrophilic block which contains negatively charged moieties (PolyAgro) and (iii) at least one non-ionic surfactant.

The Subject Invention Also Provides a High Loaded Suspension Concentrate (SC) Composition, Wherein:
i. pyroxasulfone is about 62 w/w % with respect to the total weight on the composition;
ii. PolyAgro is from about 1 to about 10 w/w % with respect to the total weight on the composition;
and
iii. at least one non-ionic surfactant is from about 1 to about 15 w/w % with respect to the total weight of the composition.

The subject invention further provides a high loaded suspension concentrate (SC) composition, wherein:
i. saflufenacil is about 53 w/w % with respect to the total weight on the composition;
ii. PolyAgro is from about 1 to about 10 w/w % with respect to the total weight on the composition; and
iii. at least one non-ionic surfactant is from about 1 to about 15 w/w % with respect to the total weight of the composition.

### DETAILED DESCRIPTION OF THE INVENTION

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

### Definitions

As used herein, the term “agricultural material” means an active ingredient used in the practice of farming, including cultivation of the soil for the growing of crops. However, the use of agricultural materials is not limited to application to crops. Agricultural materials may be applied to any surface, e.g., for the purpose of cleaning or aiding or inhibiting growth of a living organism. Other non-crop applications include, but are not limited to, application to an animal, e.g. livestock, application to turf and ornamentals, and application to railroad weed.

As used herein, the term “agrochemical” is a chemical active ingredient used in the practice of farming, including cultivation of the soil for the growing of crops. However, the use of agrochemicals is not limited to application to crops. Agrochemicals may be applied to any surface, e.g., for the purpose of cleaning or aiding or inhibiting growth of a living organism.

Examples of agricultural materials and agrochemicals include, but are not limited to, pesticides, hormones, bio-stimulants, and plant growth agents.

As used herein, the term “pesticide”, “pesticide compound” or “pesticidal compound” means a compound capable of killing or inhibiting growth or proliferation of a pest, whether for plant protection or for non-crop application. As used herein, all “pesticide”, “pesticide compound” or “pesticidal compound” fall within “agricultural material compound”. The term “pesticide”, “pesticide compound” or “pesticidal compound” includes, but is not limited to, insecticide, nematicide, herbicide, fungicide, algicides, animal repellents, and acaricides. As used herein, the term “pest” includes, but is not limited to, insect, nematode, weed, fungi, algae, mite, tick, and animal. As used herein, the term “weed” refers to any unwanted vegetation.

As used herein, the term “hydrophobic” when used to characterize a compound or a surface means that the compound or surface lacks affinity for water.

As used herein, the term “polyelectrolyte” means a polymer which contains charged monomers.

As used herein, the phrase “block copolymer” means a polymer comprising at least two different polymers combined by a covalent bond. Each of the blocks is usually a homopolymer but can also be a copolymer with a specific distinct physical/chemical or functional characteristic (e.g., having one block that is easily soluble in water, with the other block being primarily insoluble in water). As used herein, the phrase “anchoring block”, “anchoring moiety” or “ANCHOR” means a block comprised of a homopolymer or copolymer which has an affinity for the particle surface, and which will cause the block copolymer to adsorb strongly and even irreversibly to the particle surface.

As used herein, the phrase “stabilizing block”, “stabilizing moiety” or “STAB” means a * charged polymer zone for which the dispersing medium, ex. water, is a good solvent. More specifically, if a copolymer is prepared of same molar mass and composition as that of the stabilizing block, then it should be soluble in the dispersing medium at a concentration greater than or equal to 10 wt %, for instance greater than or equal to 20 wt %, for instance greater than or equal to 30 wt %, for instance greater than or equal to 40 wt %, for instance greater than or equal to 50 wt %, for instance greater than or equal to 60 wt % and even 80 wt %. As used herein, the phrase “comb copolymer” means polymers wherein side polymeric chains are bonded to a polymer/copolymeric main chain, frequently also known as the backbone. In the present case, the present polymer/copolymers have at least one repeat unit derived from polyolefin-based macromonomers.

As used herein, the term “dispersion” means a formulation which includes a heterogeneous mixture of at least two phases wherein the first (continuous phase) is liquid and the second (dispersed phase) is solid or liquid particles. The “dispersion” compositions discussed herein necessarily include an aqueous phase as the continuous phase.

As used herein, the term “suspension” and “dispersion” are interchangeable and means a formulation having solid particles that are mixed with at least one liquid phase, but which remain undissolved. Water is the continuous phase. As used herein, the phrase “capsule suspension” means a formulation having capsules containing active ingredient, surrounded by a solid coating, dispersed in water.

As used herein, the terms “particle”, “solid particle”, “liquid droplets” and capsules can be used interchangeably to mean solids and/or drops.

As used herein, particles having a “brushed structure” have a layer of polymers attached on one end to the surface of the particles and on the other end extend normal to the surface into a bulk solution. As used herein, the phrase “agriculturally acceptable carrier” means carriers, which are known and accepted in the art for the formation of formulations for agricultural or horticultural use.

As used herein, the phrase “ultra-high concentration” and “high-load concentration” means active substances in amounts of at least 500 g/L.

As used herein, the phrase “surfactant blend” means a combination and or mixture of at least 2 (two) surfactants.

As used herein, the term “agriculturally acceptable carrier” refers to a solvent which is known and accepted in the art for the formation of compositions for agricultural or horticultural use.

As used herein, the term “additive” refers to any substance that itself is not an active ingredient but is added to the composition. Examples of additives includes, but are not limited to, adjuvants, surfactants, emulsifiers, anti-freeze agents, anti-foam agents, and preservatives.

As used herein, the term “excipient” refers to any chemical which has no significant pesticidal activity, such as surfactant(s), solvent(s), or adjuvant(s). One or more excipients can be added to any composition disclosed herein.

As used herein, the term “stable” when used in connection with a composition means that the composition is physically stable and chemically stable. As used herein, the term “chemically stable” means that no significant decomposition of the active components was observed after at least 2 weeks of storage in a sealed package at a temperature of 54° C. As used herein, the term “physically stable” means that no significant sedimentation was observed after at least 2 weeks of storage in a sealed package at a temperature of 54° C.

Stability may be assessed according to test protocol established by the Collaborative International Pesticides Analytical Council Ltd. (CIPAC). Stability can be assessed under normal storage conditions which is after two years storage at room temperature. Stability can also be assessed under accelerated storage conditions which is after 2 weeks storage at 54° C. or after 8 weeks at 40° C. or after 12 weeks at 35° C. or at after 2 weeks at 0° C.

As used herein, the term “mixture” refers, but is not limited, to a combination in any physical form, e.g., blend, solution, alloy, or the like.

As used herein, the term “combination” means an assemblage of agrochemicals for application either by simultaneous or contemporaneous application.

As used herein, the term “simultaneous” when used in connection with application of agrochemicals means that the agrochemicals are applied in an admixture, for example, a tank mix. For simultaneous application, the combination may be the admixture or separate containers each containing an agrochemical that are combined prior to application.

As used herein, the term “contemporaneous” when used in connection with application of agrochemicals means that an individual agrochemical is applied separately from another agrochemical or premixture at the same time or at times sufficiently close together such that at least one benefit from combining the agrochemicals is achieved, for example, if two active components are applied contemporaneously, an activity that is additive or more than additive or synergistic relative to the activity of either active component alone at the same dose is achieved.

As used herein, the term “tank mix” means one or more of the components of the composition of the present invention are mixed in a spray tank at the time of spray application or prior to spray application.

As used herein, the term “effective” when used in connection with an amount of the combination, mixture or composition refers to an amount of the combination, mixture or composition that achieve an agriculturally beneficial level of control and/or prevention of the pest when applied to the locus where the pest is to be controlled and/or prevented.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “more effective for controlling pest” includes, but is not limited to, increasing efficacy of controlling pest and reducing the amount of time needed to achieve a given level of pest control.

As used herein, the term “more effective for preventing pest” includes, but is not limited to, increasing efficacy of preventing pest infestation and prolonging the duration of protection against pest infestation after application.

As used herein, the term “pest” includes, but is not limited to, unwanted fungus, unwanted insect, unwanted nematode, and weed.

As used herein, the term “weed” includes any undesired vegetation.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, UK, 2003-04), the contents of each of which are incorporated herein by reference in their entirety.

As used herein, the term “locus” includes not only areas where the pest may already be developed, but also areas where pest have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits.

As used herein, the term “propagation material” of the plant or crop may include all the generative parts of the plant or crop such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein the term “ha” refers to hectare.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of.” Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, used of the term “about” herein specifically includes ±10% from the indicated values in the range. In addition, the endpoints of all ranges directed to the same component/moiety/or property herein are inclusive of the endpoints, are independently combinable, and include all intermediate points and ranges.

It is understood that where a parameter range is provided, all integers within that range, and tenths thereof, are also provided by the invention.

All publications, patents and patent applications mentioned in this specification are herein incorporated in their entirety by reference into the specification, to the same extent as if each individual publication, patent or patent application was specifically and individually indicated to be incorporated herein by reference.

### Polyanionic Block Copolymer Surfactant

A polyanionic block copolymer surfactant comprising a hydrophobic moiety and a hydrophilic moiety, wherein at least 60 w/w % of the hydrophilic moiety comprises charged monomers and wherein the weight percentage of the charged monomers is at least 35 w/w % with respect to the total weight of the polyanionic block copolymer surfactant.

It is preferred that in the polyanionic block copolymer surfactant at least 90 w/w % of the hydrophobic moiety comprises hydrophobic monomers. In some cases, a small number of hydrophilic monomers (i.e., less than 10 percent by monomer number) may be introduced to the hydrophobic moiety. For example, the hydrophobic monomers are selected from the group consisting of acrylate esters or derivatives thereof, methacrylate esters or derivatives thereof, styrene or derivatives thereof, and any combination thereof.

An alkyl acrylate monomer, such as a methyl, ethyl, or butyl acrylate, is one exemplary embodiment in this regard. For example, the hydrophobic monomer is selected from a group consisting of methylacrylate, ethylacrylate, n-propylacrylate, n-butylacrylate, 2-ethyl-hexyl acrylate, methylmethacrylate, ethylmethacrylate, n-propylmethacrylate, n-butylmethacrylate, 2-ethyl-hexyl methacrylate and mixtures thereof, for example, the hydrophobic monomer is ethyl acrylate.

The hydrophilic block of the anionic surfactant can be a hydrophilic block copolymer. Said hydrophilic block comprises at least 60 w/w % of charged monomers, for example, at least 70 w/w % or at least 80 w/w % or at least 90 w/w %. In one embodiment, 100 w/w % of the hydrophilic block is made of charged monomers. Exemplary amounts of charged monomer are 68 w/w %, 77 w/w %, 83 w/w %, or 88 w/w % with respect to the hydrophilic block.

Also, the polyanionic block copolymer surfactant comprises at least 35 w/w % of charged, with respect to the total weight of the polyanionic block copolymer surfactant, preferably at least 45 w/w %, or 55 w/w %, for examples 58 w/w % with respect the total weight of the anionic surfactant.

The charged monomers of the anionic surfactant can be zwitterionic monomers, for example anionic monomers. Thus, it is preferred that at least 60 percent of the monomers in the hydrophilic moiety are anionic monomers, typically a sulfonate group, for example, 2-acrylamido-2-methylpropane sulphonate (AMPS). Therefore, less than 40 w/w % of the monomers in the hydrophilic moiety are neutral hydrophilic monomers, for example one selected from a group consisting of N-vinylpyrrolidone, ethylene oxide, glycoside acrylate, acrylamide and mixtures thereof.

Typically, the weight percentage of the hydrophilic block is at least 50 w/w %, preferably 65-90 w/w %, for example, 70-85 w/w %, with respect to the total weight of the polyanionic block copolymer surfactant.

In relation to its total weight, the polyanionic block copolymer surfactant typically comprises up to 150 monomers, or up to 85 monomers, for example 63 monomers. Thus, the weight of the polyanionic block copolymer surfactant can be up to 100,000 g/mol, typically up to about 31,000 g/mol, for example, about 17,000 g/mol, about 12,000 g/mol. Alternatively, the weight of the polyanionic block copolymer surfactant can be 8,000 to 50,000 g/mol, for example 10,000 to 25,000 g/mol.

The hydrophilic block can weight 5,000 to 100,000 g/mol, typically 6,000 to 50,000 g/mol. It, is preferred that the weight of the hydrophilic moiety is 7,000 to 30,000 g/mol, for example 8,000 to 12,000 g/mol.

The hydrophobic block can weight 500 to 5,000 g/mol, typically 1,000 to 4,000 g/mol. For example, the hydrophobic block comprises alkyl acrylate monomers, preferably ethyl acrylate monomers, and the weight of the hydrophobic block is 1,000 to 4,000 g/mol, for example 1,500 to 3,500 g/mol, preferably 1,500 to 3,000 g/mol.

Thus, it is preferred that the molar ratio of the hydrophobic block to the hydrophilic block is 1:2-4. For example, the weight ratio between the hydrophobic block and the hydrophilic block ([hydrophobic block]: [hydrophilic block]) is typically lower than 0.6, lower than or equal to 0.5, lower than or equal to 0.4, lower than or equal to 0.3, or lower than or equal to 0.2. Typically, the weight ratio between the hydrophobic block and the hydrophilic block ([hydrophobic block]: [hydrophilic block]) is between 0.01 and 0.6, for example, between 0.1 and 0.3.

For expletory purposes, the block copolymer (PolyAgro), may be presented as:

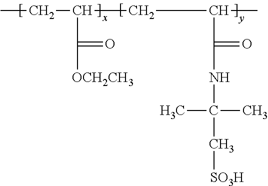 [SMILES: CCOC(=O)C(CC)CC(C)C(=O)NC(C)(C)CS(=O)(=O)O]

It was found, that the polyanionic polymers are useful in creating a stable high loaded suspension concentrates. It was surprisingly found that an addition of at least one non-ionic surfactant to said polyanionic polymers, allows to create a very high load, stable, suspension concentrate composition.

### Herbicides

Pyroxasulfone, having the chemical name 3-(5-(difluoromethoxy)-1-methyl-3-(trifluoromethyl)-1H-pyrazol-4-yl]methanesulfonyl)-5,5-dimethyl-4,5-dihydro-1,2-oxazole, has the following structural Formula (1):

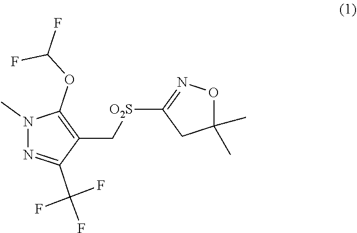

Pyroxasulfone belongs to the class of 3-([(hetero) aryl]methanesulfonyl)-4,5-dihydro-1,2-oxazoles and is used as an herbicide, in particular for pre-emergence control of annual grasses and some broad-leaved weeds in maize, soy beans, wheat and other crops. Pyroxasulfone's mode of action affects apical meristems and coleoptile development and inhibits the biosynthesis of very-long-chain fatty acids in plants with excellent herbicidal activity against grass and broadleaf weeds at lower application rates compared with other commercial herbicides. In fields of genetically modified crops, pyroxasulfone controlled weeds were resistant to non-selective herbicides. Pyroxasulfone has been classified in the Herbicide Resistance Action Committee Group K3.

Pyroxasulfone was first disclosed by Kumiai Chemical Industry Co., Ltd. and Ihara Chemical Industry Co., Ltd. in WO 2002/062770. It is available on the marketplace as water dispersible granule.

Fenoxasulfone, having the chemical name 3-[(2,5-dichloro-4-ethoxyphenyl)methylsulfonyl]-5,5-dimethyl-4H-1,2-oxazole, has the following structural Formula (2):

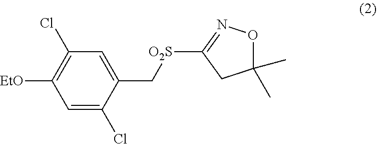 [SMILES: CCOc1cc(Cl)c(CS(=O)(=O)C2=NOC(C)(C)C2)cc1Cl]

Fenoxasulfone and pyroxasulfone share the same moiety: a 5,5-dimethyl-4H-1,2-oxazole attached through the 3-position to an arylmethylsulfone and is used as an herbicide, in particular for pre-emergence control of grass and broad-leaved weeds. Studies suggest that fenoxasulfone is a potent inhibitor of plant VLCFAEs (very-long-chain fatty acids elongase (VLCFAE)) and should be categorized within the K3 group of the Herbicide Resistance Action Committee. VLCFAE activity of recombinant Fatty Acid Elongation 1 (FAE1) of Arabidopsis, was inhibited by fenoxasulfone in a time-dependent manner, which has been shown in the inhibition of VLCFAEs by other well-known VLCFAE-inhibiting herbicides. On the other hand, VLCFAE activity of the microsomal fraction of etiolated barnyard millet seedlings, was inhibited by fenoxasulfone in a time-independent manner. This time-independent inhibition raised a new inhibition mechanism of VLCFAE by fenoxasulfone likely with pyroxasulfone, which is classified in the same chemical class as fenoxasulfone, as has been showed in Journal of Pesticide Science, 2011, Vol. 36 Issue 3, p357-362.

Fenoxasulfone is a novel rice herbicide that was discovered and developed by Kumiai Chemical Industry Co., Ltd. It displays excellent herbicidal activity against Echinochloa spp. and other annual weeds at 150-200 g a.i./ha with long residual activity and has a favorable toxicological, ecotoxicological, and environmental profile. Fenoxasulfone's mode of action was investigated, and it has been shown to inhibit the biosynthesis of very-long-chain fatty acids in plants. Fenoxasulfone was registered in Japan in 2014, and various products containing fenoxasulfone have been launched. With its high efficacy and long residual activity, it is estimated that fenoxasulfone will contribute to efficient food production in the future, as cited from J Pestic Sci, 2019 Jul. 25; 44 (4): 282-289.

Additional herbicides which contain the 5,5-dimethyl-4H-1,2-oxazole moiety, have been reported in WO 2010/145992 and WO 2011/018486 including, but not limited to:

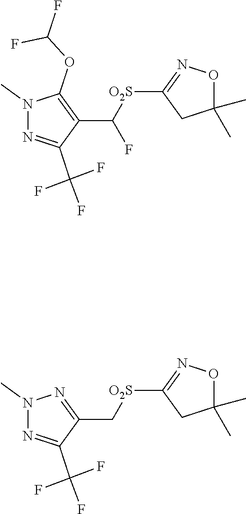

Pyroxasulfone's method of preparation was described in several patent applications namely WO 2006/068092 in the name of Ihara, WO 2004/013106 in the name of Kumiai and Ihara and WO 2005/095352 in the name of Ihara.

### SC Composition

Suspension concentrate (SC) formulations are a very important kind of formulations in the agrochemical field and are preferred by the farmers over other solid formulations such as powders and granules. The SC formulations consist of having a solid active ingredient dispersed in water.

SCs have grown in popularity due to benefits such as absence of dust, ease of use and effectiveness when compared to other formulation types such as emulsifiable concentrate (EC) and wettable powder (WP). To formulate a stable SC, the active ingredient must remain insoluble under all temperature conditions. Moreover, it is not trivial and somewhat challenging to create a high loaded stable SC composition. Especially, without persistent foam, layer separation and caking.

The following examples illustrate the practice of the present subject matter in some of its embodiments but should not be construed as limiting the scope of the present subject matter. Other embodiments apparent to persons of ordinary skill in the art from consideration of the specification and examples herein that fall within the spirit and scope of the appended claims are part of this invention. The specification, including the examples, is intended to be exemplary only, without limiting the scope and spirit of the invention.

Aspects and embodiments of the present invention will now be described.

The present invention provides a high loaded suspension concentrate (SC) composition comprising (i) a pesticide, (ii) a block copolymer, composed of a hydrophobic block and a hydrophilic block which contains negatively charged moieties (PolyAgro) and (iii) at least one non-ionic surfactant.

In some embodiments, wherein the pesticide is selected from insecticide, nematicide, herbicide, fungicide, algicides, animal repellents, and acaricides.

In some embodiments, the pesticide is a herbicide.

In some embodiments, wherein the herbicide is selected from, aclonifen, ametryn, atrazine, benazolin, benzobicyclon, benzofenap, bifenox, bixlozone, bromoxynil, chloridazon, chlorotoluron, cyanazine, daimuron, desmedipham, dicamba, diflufenican, dimethipin, dipropetryn, diuron, DNOC, ethidimuron, ethofumesate, ethoxysulfuron, fentrazamide, florasulam, flufenacet, flumetsulam, flumipropyn, fluometuron, flupoxam, fluridone, foramsulfuron, imazamethabenz-methyl, imazosulfuron, indanofan, indaziflam, isoproturon, isouron, isoxaben, isoxaflutole, isoxapyrifop, karbutilate, lenacil, linuron, mefenacet, mesotrione, metamitron, metazachlor, metazosulfuron, methiozolin, metobromuron, metosulam, metoxuron, metribuzin, napropamide, nicosulfuron, oryzalin, oxadiargyl, oxadiazon, oxaziclomefone, oxyfluorfen, paraquat dichloride, pendimethalin, penoxsulam, pentoxazone, phenmedipham, picolinafen, prometryn, propachlor, propanil, propham, propyrisulfuron, propyzamide, pyraflufen-ethyl, pyrazosulfuron-ethyl, pyrazoxyfen, pyributicarb, pyriftalid, pyroxasulfone, quinclorac, quinmerac, saflufenacil, simazine, sodium chlorate, sulcotrione, sulfentrazone, terbumeton, terbuthylazine, terbutryn.

In some embodiments, wherein the herbicide is pyroxasulfone.

In some embodiments, wherein the herbicide is saflufenacil.

In some embodiments, wherein the pesticide is from about 45 to about 75 w/w % with respect to the total weight of the composition.

In some embodiments, wherein the herbicide is pyroxasulfone and is from 50 to about 80 w/w % with respect to the total weight of the composition.

In some embodiments, wherein the herbicide is saflufenacil and is from 50 to about 70 w/w % with respect to the total weight of the composition.

In some embodiments, wherein the pesticide is about 45 w/w % with respect to the total weight of the composition.

In some embodiments, wherein the pesticide is about 55 w/w % with respect to the total weight of the composition.

In some embodiments, wherein the pesticide is about 65 w/w % with respect to the total weight of the composition.

In some embodiments, wherein the pesticide is about 75 w/w % with respect to the total weight of the composition.

In some embodiments, wherein the herbicide is from about 45 to about 75 w/w % with respect to the total weight of the composition.

In some embodiments, wherein the herbicide is about 45 w/w % with respect to the total weight of the composition.

In some embodiments, wherein the herbicide is about 55 w/w % with respect to the total weight of the composition.

In some embodiments, wherein the herbicide is about 65 w/w % with respect to the total weight of the composition.

In some embodiments, wherein the herbicide is about 75 w/w % with respect to the total weight of the composition.

In some embodiments, wherein the PolyAgro is a polyelectrolyte-layer forming copolymer.

In some embodiments, wherein the PolyAgro comprises (a) an anchoring moiety and (b) at least one stabilizing moiety.

In some embodiments, wherein the PolyAgro comprising a hydrophobic block and a hydrophilic block, wherein at least 60 w/w % of the hydrophilic block comprises charged monomers and wherein the weight percentage of the charged monomers is at least 35 w/w % with respect to the total weight of the PolyAgro.

In some embodiments, wherein the PolyAgro is from about 0.1 to about 80 w/w % with respect to the total weight of the composition.

In some embodiments, wherein the PolyAgro is from about 0.1 to about 50 w/w % with respect to the total weight of the composition.

In some embodiments, wherein the PolyAgro is from about 0.1 to about 20 w/w % with respect to the total weight of the composition.

In some embodiments, wherein the PolyAgro is from about 0.1 to about 10 w/w % with respect to the total weight of the composition.

As described herein, the PolyAgro is a block copolymer, composed of a hydrophobic block and a hydrophilic block which contains negatively charged moieties (PolyAgro), thus it is apparent that it may be in the form of di-block copolymer, tri-block copolymer, and etc.

In some embodiments, wherein the non-ionic surfactant is selected from wetters and dispersants.

In some embodiments, wherein the non-ionic surfactant is a dispersant.

In some embodiments, wherein the dispersant is selected from alkyl block copolymer, alkynaphthalene sulfonates, PVP, PVP-VA, PVA, tristyrylphenol ethoxylates, their phosphate and sulfonate esters and their salts, poly acrylic graft copolymer, vegetable oil ethoxylates, alcohol ethoxylates.

In some embodiments, wherein the dispersant is a poly acrylic graft copolymer.

A polymeric surfactant of the poly acrylic graft copolymer, for example, is that comprises a backbone of (meth)acrylate grafted with polyalkyloxide chains, preferably a polymeric surfactant that comprises a backbone of alkyl(meth)acrylate grafted with polyalkyloxide chains, for example one that comprises a backbone of methyl(meth)acrylate grafted with chains of polyalkyloxide, wherein the alkyl is selected from the group consisting of ethyl, propyl and a mixture of both.

In some embodiments, wherein the poly acrylic graft copolymer is from about 0.1 to about 80 w/w % with respect to the total weight of the composition.

In some embodiments, wherein the poly acrylic graft copolymer is from about 0.1 to about 50 w/w % with respect to the total weight of the composition.

In some embodiments, wherein the poly acrylic graft copolymer is from about 0.1 to about 20 w/w % with respect to the total weight of the composition.

In some embodiments, wherein the poly acrylic graft copolymer is from about 0.1 to about 10 w/w % with respect to the total weight of the composition.

In some embodiments, wherein the non-ionic surfactant is a wetter.

In some embodiments, wherein the wetter is selected from an alcohol ethoxylate (including linear and branched, and different degrees of ethoxylation), alcohol ethoxylate-propoxylate (including linear and branched, and different degrees of ethoxy-propoxylation), EO-PO nonionic surfactants, alkyl block copolymers.

In some embodiments, wherein the wetter is 2-ethyl hexanol EO-PO nonionic surfactant.

In some embodiments, wherein the alcohol EO-PO nonionic surfactant is from about 0.1 to about 80 w/w % with respect to the total weight of the composition.

In some embodiments, wherein the alcohol EO-PO nonionic surfactant is from about 0.1 to about 15 w/w % with respect to the total weight of the composition.

In some embodiments, wherein the alcohol EO-PO nonionic surfactant is from about 0.1 to about 10 w/w % with respect to the total weight of the composition.

In some embodiments, wherein the alcohol EO-PO nonionic surfactant is from about 0.1 to about 5 w/w % with respect to the total weight of the composition.

In some embodiments, wherein the SC composition comprising (i) a herbicide, (ii) a block copolymer, composed of a hydrophobic block and a hydrophilic block which contains negatively charged moieties (PolyAgro) and (iii) at least one non-ionic surfactant selected from alkyl alkoxylates and poly acrylic graft copolymers.

In some embodiments, wherein the SC composition comprising (i) a herbicide, (ii) a block copolymer, composed of a hydrophobic block and a hydrophilic block which contains negatively charged moieties (PolyAgro) and (iii) a non-ionic surfactant blend selected from alkyl alkoxylates and poly acrylic graft copolymers.

In some embodiments, wherein the SC composition, wherein the non-ionic surfactant blend comprising a combination of alkyl alkoxylates and poly acrylic graft copolymers at any effective ratios.

In some embodiments, wherein the non-ionic surfactant blend comprising a combination of alkyl alkoxylates and poly acrylic graft copolymers is from about 1:10 to 10:1.

In some embodiments, wherein the high loaded SC composition is stable.

In some embodiments, wherein the SC composition has low foaming during processing and low persistent foam.

In some embodiments, wherein the composition comprises an amount of at least one additive.

In some embodiments, wherein the additive is selected from the group consisting of adjuvants, surfactants, emulsifiers, anti-freeze agents, anti-foam agents, solvents, co-solvents and preservatives.

In some embodiments, wherein the amount of additive(s) in the SC composition is from about 0.1 to about 80 w/w % with respect to the total weight of the composition.

In some embodiments, wherein the composition comprises at least one agriculturally acceptable carrier.

In some embodiments, wherein the amount of the agriculturally acceptable carrier in the composition is from about 0.1 to about 90 w/w % with respect to the total weight on the composition.

In another aspect of the present invention is a high loaded suspension concentrate (SC) composition, wherein:
i. pyroxasulfone is about 62 w/w % with respect to the total weight on the composition;
ii. PolyAgro is from about 1 to about 10 w/w % with respect to the total weight on the composition; and
iii. at least one non-ionic surfactant is from about 1 to about 15 w/w % with respect to the total weight of the composition.

In another aspect of the present invention is a high loaded suspension concentrate (SC) composition, wherein:
i. saflufenacil is about 53 w/w % with respect to the total weight on the composition;
ii. PolyAgro is from about 1 to about 10 w/w % with respect to the total weight on the composition; and
iii. at least one non-ionic surfactant is from about 1 to about 15 w/w % with respect to the total weight of the composition.

In some embodiments, wherein the composition comprises at least one additional pesticide and/or safener.

In some embodiments, wherein the composition comprises at least one additional herbicide and/or safener.

In some embodiments, wherein the pesticide is a herbicide selected from the group consisting of 2,4-D, imazethapyr, pyroxasulfone, S-metolachlor, glufosinate, halauxifen, tembotrione, bixlozone, glyphosate, carfentrazone, thiencarbazone, sulfentrazone, dimethenamide-P, mesotrione, isoxaflutole, metribuzin and bicycopyrone; and/or esters or salts thereof.

In some embodiments, wherein the composition is comprising 25% water, based on the total weight on the composition.

In some embodiments, wherein a combination comprising the SC composition and at least one additional pesticide.

In some embodiments, wherein the combination is more effective for controlling and/or preventing pest than when each pesticide at the same amount is applied alone.

In some embodiments, wherein the combination comprising an amount of pyroxasulfone and the additional pesticide(s) when applied together is more effective for controlling and/or preventing pest than when each pesticide at the same amount is applied alone.

In some embodiments, wherein the combination comprising an amount of saflufenacil and the additional pesticide(s) when applied together is more effective for controlling and/or preventing pest than when each pesticide at the same amount is applied alone.

In some embodiments, wherein a method of controlling and/or preventing pests comprising applying an effective amount of the SC composition described herein or the combination described herein, to a locus where the pest is to be controlled and/or prevented so as to thereby control and/or prevent the pest.

In some embodiments, wherein the method described herein, wherein the pest is weed.

In some embodiments, wherein a method for controlling weed comprising applying an effective amount of the SC composition described herein or the combination described herein, to a locus where the weed is to be controlled so as to thereby control the weed.

In some embodiments, wherein the method described herein, wherein the locus is a crop field.

In some embodiments, wherein the method described herein, wherein the crop is selected from the group consisting of cotton, rice, banana, potato, coffee, sugar cane, citrus, beans, sunflower, apple, corn, soybean, wheat, triticale, barley, oats, chickpeas, field peas, lentils, lupins, peanuts, fruit trees, nut trees, and grain sorghum.

In some embodiments, wherein the method described herein, wherein the weed is Hordeum murinum ssp. leporium, Echinochloa crus-galli, Poa annua, Bromus tectorum, Bromus japonicus, Phalaris canariensis, Bromus secalinus, Digitaria sanguinalis, Digitaria ischaemum, Dactyloctenium aegyptium, Eriochloa acuminata, Erichola villosa, Setaria faberi, Setaria viridis, Setaria pumila, Eleusine indica, Sorghum halepense, Urochola texana, Panicum miliaceum, Avena fatua, Panicum dichotomiflorum, Oryza sativa, Lolium perenne ssp. Multiflorum, Lolium rigidum, Cenchrus, longispinus, Sorghum bicolor ssp. Arundinaceum, Urochloa platyphylla, Vulpia myuros, Cyperus esculentus, Amaranthus palmeri, Amaranthus powelli, Polygonum convolvulus, Mollugo verticillate, Stellaria media, Conyza bonariensis, Senecio vulgaris, Lamium amplexicaule, Conyza canadensis, Datura stramonium, Kochia scoparia, Chenopodium album, Ipomoea hederacea, Ipomoea lacunose, Solanum nigrum, Solanum ptychanthum, Amaranthus ssp., Amaranthus retroflexus, Amaranthus hybridus, Amaranthus albus, Portulca oleracea, Richardia scabra, Ambrosia artemisiifolia, Capsella bursa-pastoris, Sida spinosa, Abutilon theophrasti, Amaranthus teberculatus, Descurainia Sophia, Sinapsis arvensis L.

In some embodiments, wherein the method described herein, wherein the SC composition, combination or mixture is applied pre-plant incorporated, pre-emergence or post-emergence.

In some embodiments, wherein the method described herein, wherein the SC composition or combination is applied to pasture, non-crop areas and/or fallow.

In some embodiments, wherein the method described herein, wherein the SC composition or combination is applied as pre-harvest aid.

In some embodiments, wherein the method described herein, wherein the SC composition or combination is applied at an amount from about 0.001 L/ha to about 0.5 L/ha.

In some embodiments, wherein the method described herein, wherein the SC composition or combination is applied at an amount from about 0.01 g/ha of pyroxasulfone to about 300 g/ha of pyroxasulfone.

In some embodiments, wherein a package comprising the SC composition described herein or the combination described herein.

In some embodiments, wherein a process for preparing the SC composition described herein, wherein the process comprises:
a. mixing of the PolyAgro, at least one non-ionic surfactant and additives with water;
b. addition of the pesticide and milling to reduce particle size; and
c. addition of rheology modifiers and additives.

### EXAMPLES

### Example 1. Pyroxasulfone 66%, Dioctyl Sodium Sulfosuccinate Solution 0.5%, Alcohol Ethoxylate/Propoxylate 3%, Polydimethylsiloxane Emulsion 0.4%, Xanthan Gum 0.1%, and Water 30%

| | | % |
|---|---|---|
| Pyroxasulfone | Al | 66.0 |
| Dioctyl sodium | wetter | 0.5 |
| sulfosuccinate solution | | |
| alcohol | nonionic | 3.0 |
| ethoxylate/propoxylate | dispersant | |
| Polydimethylsiloxane | antifoam | 0.4 |
| emulsion | | |
| Xanthan gum | thickener | 0.1 |
| water | continuous | 30.0 |
| | phase | |

This composition was found to be unsuccessful, it presented with very high viscosity and a lot of foaming.

As it may be clearly shown, without the PolyAgro component, the formulation is not good.

### Example 2. Pyroxasulfone 63%, PolyAgro 2.5%, Polyacrylic Graft Copolymer 2.5%, Alcohol Ethoxylate/Propoxylate 1%, Polydimethylsiloxane Emulsion 0.5%, Xanthan Gum 0.1%, Propylene Glycol 5%, and Water 25.4%

| | | % |
|---|---|---|
| Pyroxasulfone | Al | 63.0 |
| PolyAgro | anionic | 2.5 |
| | dispersant | |
| poly acrylic graft | nonionic | 2.5 |
| copolymer | dispersant | |
| Alcohol | wetter | 1.0 |
| ethoxylate/propoxylate | | |
| Polydimethylsiloxane | antifoam | 0.5 |
| emulsion | | |
| Xanthan gum | thickener | 0.1 |
| Propylene glycol | antifreeze | 5.0 |
| water | continuous | 25.4 |
| | phase | |

This composition showed low viscosity before milling-often <100 cP, and also after milling. There was not much foaming during processing. The composition presented with good formulation properties-chemical stability, stable viscosity, good suspensibility.

As it may be clearly shown, the presence of PolyAgro in the composition is critical, but also the addition of another non-ionic surfactant.

### Example 3. Pyroxasulfone 63%, PolyAgro 2.5%, Polyacrylic Graft Copolymer 2.5%, Alcohol Ethoxylate/Propoxylate 1%, Polydimethylsiloxane Emulsion 0.5%, Xanthan Gum 0.1%, Silica 0.1%, Propylene Glycol 3%, and Water 25.6%

| | | % |
|---|---|---|
| Pyroxasulfone | Al | 63.0 |
| PolyAgro | anionic | 2.5 |
| | dispersant | |
| poly acrylic graft | nonionic | 2.5 |
| copolymer | dispersant | |
| Alcohol | wetter | 1.0 |
| ethoxylate/propoxylate | | |
| Polydimethylsiloxane | antifoam | 0.5 |
| emulsion | | |
| Xanthan gum | thickener | 0.1 |
| Silica | anti-caking agent | 0.1 |
| Propylene glycol | antifreeze | 3.0 |
| water | continuous | 27.3 |
| | phase | |

Additional good composition, this composition showed low viscosity before milling-often <100 cP, and also after milling. There was not much foaming during processing. The composition presented with good formulation properties-chemical stability, stable viscosity, good suspensibility.

As it may be clearly shown, the presence of PolyAgro in the composition is critical, but also the addition of another non-ionic surfactant.

In comparison of example 1 to examples 2 and 3, it may be clearly shown, that a high load good SC composition may be achieved by using a PolyAgro surfactant with an addition of at least one non-ionic surfactant.

### Example 4. Saflufenacil 53.84%, PolyAgro 1.92%, Polyacrylic Graft Copolymer 1.92%, Xanthan Gum 0.13%, Alcohol Alkoxylate 1%, Polydimethylsiloxane Emulsion 0.17%, Glycerin 2.92%, Citric Acid 0.1%, 1,2-Benzisothiazolin-3-One 0.065% and Water 22.3%

| | | % |
|---|---|---|
| Saflufenacil | Herbicide | 53.84 |
| Xanthan gum | Thickener | 0.13 |
| Polyacrylic graft | Dispersant | 1.92 |
| copolymer | | |
| Citric Acid | PH_Modifier | 0.1 |
| PolyAgro | Dispersant | 1.92 |
| Glycerine | Antifreeze | 2.92 |
| Alcohol alkoxylate | Wetting_Agent | 1 |
| 1,2-Benzisothiazolin- | Bactericide | 0.065 |
| 3-one | | |
| Polydimethylsiloxane | Antifoam | 0.17 |
| water | Solvent | 4.65 |
| water | Solvent | Up to |
| | | 100% |

An additional example with other herbicide-saflufenacil, which clearly demonstrates, that the use of PolyAgro with an addition of at least one non-ionic surfactant, yield a stable high loaded formulation.

### Method of Preparation

The suspension concentrate (SC) formulations containing saflufenacil or pyroxasulfone as described in examples 1 to 4 were prepared as follows:

### Step I: Preparation of Agriculturally Acceptable Inert Additives Premix

Soft water and all the excipients, not including the anti freeze and the thickener, were charged to the vessel and mixed (high shear) to form a solution. The content of the vessel was heated to 60° C. to form a homogeneous solution.

### Step II: Preparation of the SC Formulation

Step I premix was cooled to room temperature. The active ingredient compound (e.g. saflufenacil or pyroxasulfone) was added to the premix with the surfactants inside, the suspension was milled in a bead mill (0.8-1.2 mm beads) until a particle size distribution of d90<5 μm was reached. The milled suspension was drained from the reactor to new vessel.

### Step III: Finalization of the Composition

Anti freeze was added to the milled suspension and mixed until a uniform suspension was obtained. The thickener was added to the suspension while mixing until a viscosity of 1600-2200 cP was reached. Mixing was continued until a homogenous solution was obtained. Viscosity was measured by viscometer according to CIPAC method MT 192.

1. A high loaded suspension concentrate (SC) composition comprising (i) a pesticide, (ii) a block copolymer, composed of a hydrophobic block and a hydrophilic block which contains negatively charged moieties (PolyAgro) and (iii) at least one non-ionic surfactant.

2. The composition according to claim 1, wherein the pesticide is selected from insecticide, nematicide, herbicide, fungicide, algicides, animal repellents, and acaricides.

3. The composition according to claim 2, wherein the pesticide is a herbicide.

4. The composition according to claim 3, wherein the herbicide is selected from, aclonifen, ametryn, atrazine, benazolin, benzobicyclon, benzofenap, bifenox, bixlozone, bromoxynil, chloridazon, chlorotoluron, cyanazine, daimuron, desmedipham, dicamba, diflufenican, dimethipin, dipropetryn, diuron, DNOC, ethidimuron, ethofumesate, ethoxysulfuron, fentrazamide, florasulam, flufenacet, flumetsulam, flumipropyn, fluometuron, flupoxam, fluridone, foramsulfuron, imazamethabenz-methyl, imazosulfuron, indanofan, indaziflam, isoproturon, isouron, isoxaben, isoxaflutole, isoxapyrifop, karbutilate, lenacil, linuron, mefenacet, mesotrione, metamitron, metazachlor, metazosulfuron, methiozolin, metobromuron, metosulam, metoxuron, metribuzin, napropamide, nicosulfuron, oryzalin, oxadiargyl, oxadiazon, oxaziclomefone, oxyfluorfen, paraquat dichloride, pendimethalin, penoxsulam, pentoxazone, phenmedipham, picolinafen, prometryn, propachlor, propanil, propham, propyrisulfuron, propyzamide, pyraflufen-ethyl, pyrazosulfuron-ethyl, pyrazoxyfen, pyributicarb, pyriftalid, pyroxasulfone, quinclorac, quinmerac, saflufenacil, simazine, sodium chlorate, sulcotrione, sulfentrazone, terbumeton, terbuthylazine, terbutryn.

5. The composition according to claim 4, wherein the herbicide is pyroxasulfone.

6. The composition according to claim 4, wherein the herbicide is saflufenacil.

7. The composition according to any of claims 3 to 5, wherein the herbicide is from about 45 to about 75 w/w % with respect to the total weight of the composition.

8. The composition according to any of claims 3 to 5, wherein the herbicide is pyroxasulfone and is from 50 to about 80 w/w % with respect to the total weight of the composition.

9. The composition according to any of claim 3, 4 or 6, wherein the herbicide is saflufenacil and is from 50 to about 70 w/w % with respect to the total weight of the composition.

10. The composition according to claim 6, wherein the herbicide is about 45 w/w % with respect to the total weight of the composition.

11. The composition according to claim 6, wherein the herbicide is about 55 w/w % with respect to the total weight of the composition.

12. The composition according to claim 6, wherein the herbicide is about 65 w/w % with respect to the total weight of the composition.

13. The composition according to claim 6, wherein the herbicide is about 75 w/w % with respect to the total weight of the composition.

14. The composition according to claim 8, wherein the herbicide is about 50 w/w % with respect to the total weight of the composition.

15. The composition according to claim 8, wherein the herbicide is about 55 w/w % with respect to the total weight of the composition.

16. The composition according to claim 8, wherein the herbicide is about 60 w/w % with respect to the total weight of the composition.

17. The composition according to claim 8, wherein the herbicide is about 65 w/w % with respect to the total weight of the composition.

18. The composition according to claim 1, wherein the PolyAgro is a polyelectrolyte-layer forming copolymer.

19. The composition according to claim 18, wherein the PolyAgro comprises (a) an anchoring moiety and (b) at least one stabilizing moiety.

20. The composition according to any of claims 18 to 19, wherein the PolyAgro comprises a hydrophobic block and a hydrophilic block, wherein at least 60 w/w % of the hydrophilic block comprises charged monomers and wherein the weight percentage of the charged monomers is at least 35 w/w % with respect to the total weight of the PolyAgro.

21. The composition according to any of claims 18 to 20, wherein the PolyAgro is from about 0.1 to about 80 w/w % with respect to the total weight of the composition.

22. The composition according to any of claims 18 to 21, wherein the PolyAgro is from about 0.1 to about 50 w/w % with respect to the total weight of the composition.

23. The composition according to any of claims 18 to 21, wherein the PolyAgro is from about 0.1 to about 20 w/w % with respect to the total weight of the composition.

24. The composition according to any of claims 18 to 21, wherein the PolyAgro is from about 0.1 to about 10 w/w % with respect to the total weight of the composition.

25. The composition according to claim 1, wherein the non-ionic surfactant is selected from wetters and dispersants.

26. The composition according to claim 25, wherein the non-ionic surfactant is a dispersant.

27. The composition according to claim 26, wherein the dispersant is selected from alkyl block copolymer, alkynaphthalene sulfonates, PVP, PVP-VA, PVA, tristyrylphenol ethoxylates, their phosphate and sulfonate esters and their salts, poly acrylic graft copolymer, vegetable oil ethoxylates, alcohol ethoxylates.

28. The composition according to any of claims 26 to 27, wherein the dispersant is a poly acrylic graft copolymer.

29. The composition according to claim 28, wherein the poly acrylic graft copolymer is from about 0.1 to about 80 w/w % with respect to the total weight of the composition.

30. The composition according to claim 28, wherein the poly acrylic graft copolymer is from about 0.1 to about 50 w/w % with respect to the total weight of the composition.

31. The composition according to claim 28, wherein the poly acrylic graft copolymer is from about 0.1 to about 20 w/w % with respect to the total weight of the composition.

32. The composition according to claim 28, wherein the poly acrylic graft copolymer is from about 0.1 to about 10 w/w % with respect to the total weight of the composition.

33. The composition according to claim 25, wherein the non-ionic surfactant is a wetter.

34. The composition according to any of claim 25 or 33, wherein the wetter is selected from an alcohol ethoxylate (including linear and branched, and different degrees of ethoxylation), alcohol ethoxylate-propoxylate (including linear and branched, and different degrees of ethoxy-propoxylation), EO-PO nonionic surfactants, alkyl block copolymers.

35. The composition according to claim 34, wherein the wetter is 2-ethyl hexanol EO-PO nonionic surfactant.

36. The composition according to claim 35, wherein the alcohol EO-PO nonionic surfactant is from about 0.1 to about 80 w/w % with respect to the total weight of the composition.

37. The composition according to claim 35, wherein the alcohol EO-PO nonionic surfactant is from about 0.1 to about 15 w/w % with respect to the total weight of the composition.

38. The composition according to claim 35, wherein the alcohol EO-PO nonionic surfactant is from about 0.1 to about 10 w/w % with respect to the total weight of the composition.

39. The composition according to claim 35, wherein the alcohol EO-PO nonionic surfactant is from about 0.1 to about 5 w/w % with respect to the total weight of the composition.

40. The composition according to any of claims 1 to 39, wherein the SC composition comprises (i) a herbicide, (ii) a block copolymer, composed of a hydrophobic block and a hydrophilic block which contains negatively charged moieties (PolyAgro) and (iii) at least one non-ionic surfactant selected from alkyl alkoxylates and poly acrylic graft copolymers.

41. The composition according to any of claims 1 to 39, wherein the SC composition comprises (i) a herbicide, (ii) a block copolymer, composed of a hydrophobic block and a hydrophilic block which contains negatively charged moieties (PolyAgro) and (iii) a non-ionic surfactant bled selected from alkyl alkoxylates and poly acrylic graft copolymers.

42. The composition according to any of claim 1 or 3, wherein the non-ionic surfactant blend comprises a combination of alkyl alkoxylates and poly acrylic graft copolymers at any effective ratios.

43. The composition according to any of claims 1 to 39, wherein the non-ionic surfactant blend comprising a combination of alkyl alkoxylates and poly acrylic graft copolymers is from about 10:1 to 1:10.

44. The composition according to any of previous claims 1 to 43, wherein the high loaded SC composition is stable.

45. The composition according to any of previous claims 1 to 44, wherein the SC composition has low foaming during processing and low persistent foam.

46. The composition according to any of previous claims 1 to 45, wherein the composition comprises an amount of at least one additive.

47. The composition according to claim 45, wherein the additive is selected from the group consisting of adjuvants, surfactants, emulsifiers, anti-freeze agents, anti-foam agents, solvents, co-solvents and preservatives.

48. The composition according to any of claims 46 to 47, wherein the amount of additive(s) in the SC composition is from about 0.1 to about 80 w/w % with respect to the total weight of the composition.

49. The composition according to any of previous claims 1 to 48, wherein the composition comprises at least one agriculturally acceptable carrier.

50. The composition according to claim 49, wherein the amount of the agriculturally acceptable carrier in the composition is from about 0.1 to about 90 w/w % with respect to the total weight on the composition.

51. A high loaded suspension concentrate (SC) composition, wherein:
i. pyroxasulfone is about 62 w/w % with respect to the total weight on the composition;
ii. PolyAgro is from about 1 to about 10 w/w % with respect to the total weight on the composition; and
iii. at least one non-ionic surfactant is from about 1 to about 15 w/w % with respect to the total weight of the composition.

52. A high loaded suspension concentrate (SC) composition, wherein:
i. saflufenacil is about 53 w/w % with respect to the total weight on the composition;
ii. PolyAgro is from about 1 to about 10 w/w % with respect to the total weight on the composition; and
iii. at least one non-ionic surfactant is from about 1 to about 15 w/w % with respect to the total weight of the composition.

53. The composition according to any of claims 46 to 52, wherein the composition comprises at least one additional pesticide and/or safener.

54. The composition according to claim 53, wherein the pesticide is a herbicide selected from the group consisting of 2,4-D, imazethapyr, pyroxasulfone, S-metolachlor, glufosinate, halauxifen, tembotrione, bixlozone, glyphosate, carfentrazone, thiencarbazone, sulfentrazone, dimethenamide-P, mesotrione, isoxaflutole, metribuzin and bicycopyrone; and/or esters or salts thereof.

55. The composition according to any of claims 46 to 54, wherein the composition is comprising 25% water, based on the total weight on the composition.

56. A combination comprising the SC composition of any one of claims 1 to 55, and at least one additional pesticide.

57. The combination according to claim 56, wherein the combination is more effective for controlling and/or preventing pest than when each pesticide at the same amount is applied alone.

58. The combination according to any of claim 56 or 57, wherein the amount of pyroxasulfone and the additional pesticide(s) when applied together is more effective for controlling and/or preventing pest than when each pesticide at the same amount is applied alone.

59. The combination according to any of claim 56 or 57, wherein the amount of saflufenacil and the additional pesticide(s) when applied together is more effective for controlling and/or preventing pest than when each pesticide at the same amount is applied alone.

60. A method of controlling and/or preventing pests comprising applying an effective amount of the SC composition according to any of claims 1 to 55 or the combination according to any of claims 56 to 59, to a locus where the pest is to be controlled and/or prevented so as to thereby control and/or prevent the pest.

61. The method according to claim 60, wherein the pest is weed.

62. A method for controlling weed comprising applying an effective amount of the SC composition according to any of claims 1 to 55 or the combination according to any of claims 56 to 59, to a locus where the weed is to be controlled so as to thereby control the weed.

63. The method according to any of claims 60 to 62, wherein the locus is a crop field.

64. The method according to any of claims 60 to 63, wherein the crop is selected from the group consisting of cotton, rice, banana, potato, coffee, sugar cane, citrus, beans, sunflower, apple, corn, soybean, wheat, triticale, barley, oats, chickpeas, field peas, lentils, lupins, peanuts, fruit trees, nut trees, and grain sorghum.

65. The method according to any of claims 60 to 64, wherein the weed is Hordeum murinum ssp. leporium, Echinochloa crus-galli, Poa annua, Bromus tectorum, Bromus japonicus, Phalaris canariensis, Bromus secalinus, Digitaria sanguinalis, Digitaria ischaemum, Dactyloctenium aegyptium, Eriochloa acuminata, Erichola villosa, Setaria faberi, Setaria viridis, Setaria pumila, Eleusine indica, Sorghum halepense, Urochola texana, Panicum miliaceum, Avena fatua, Panicum dichotomiflorum, Oryza sativa, Lolium perenne ssp. Multiflorum, Lolium rigidum, Cenchrus, longispinus, Sorghum bicolor ssp. Arundinaceum, Urochloa platyphylla, Vulpia myuros, Cyperus esculentus, Amaranthus palmeri, Amaranthus powelli, Polygonum convolvulus, Mollugo verticillate, Stellaria media, Conyza bonariensis, Senecio vulgaris, Lamium amplexicaule, Conyza canadensis, Datura stramonium, Kochia scoparia, Chenopodium album, Ipomoea hederacea, Ipomoea lacunose, Solanum nigrum, Solanum ptychanthum, Amaranthus ssp., Amaranthus retroflexus, Amaranthus hybridus, Amaranthus albus, Portulca oleracea, Richardia scabra, Ambrosia artemisiifolia, Capsella bursa-pastoris, Sida spinosa, Abutilon theophrasti, Amaranthus teberculatus, Descurainia Sophia, Sinapsis arvensis L.

66. The method according to any of claims 60 to 65, wherein the SC composition, combination or mixture is applied pre-plant incorporated, pre-emergence or post-emergence.

67. The method according to any of claims 60 to 66, wherein the SC composition or combination is applied to pasture, non-crop areas and/or fallow.

68. The method according to any of claims 60 to 67 wherein the SC composition or combination is applied as pre-harvest aid.

69. The method according to any of claims 60 to 68, wherein the SC composition or combination is applied at an amount from about 0.001 L/ha to about 0.5 L/ha.

70. The method according to any of claims 60 to 69, wherein the SC composition or combination is applied at an amount from about 0.01 g/ha of pyroxasulfone to about 300 g/ha of pyroxasulfone.

71. A package comprising the SC composition according to any of claims 1 to 55 or the combination according to any of claims 56 to 59.

72. A process for preparing the SC composition according to any of claims 1 to 55, wherein the process comprises:
a. mixing of the PolyAgro, at least one non-ionic surfactant and additives with water;
b. addition of the pesticide and milling to reduce particle size; and
c. addition of rheology modifiers and additives.
